(19) United States
(12) Patent Application Publication
(10) Pub. No.: US 2014/0116225 A1
(43) Pub. Date: May 1, 2014

(54) GLIDING PART TO BE FASTENED TO A FRAME OF A SAWING DEVICE

(71) Applicant: Reijo Viljanen, Tampere (FI)

(72) Inventor: Reijo Viljanen, Tampere (FI)

(21) Appl. No.: 14/131,435

(22) PCT Filed: Jul. 8, 2011
(86) PCT No.: PCT/FI2011/000035

§ 371 Date: Jan. 8, 2014

(51) Int. Cl. B27B 13/08; B27B 13/10

(52) U.S. Cl. CPC B27B 13/08; B27B 13/10
USPC 83/814

(57) ABSTRACT

Arrangement in order to tension a counter element (1), such as a blade of a sawing device, such as a blade (15) of a band sawing machine in combination with a roll or a slide block to a chosen sawing line with the help of the mentioned counter element and in order to direct the counter element to make it stay at the mentioned line. The arrangement comprises a magnetic device (14) in order to improve the functioning belonging to the counter element (1) and in order to improve the sawing result with the help of which magnetic force created by the magnetic device the blade (15) is being controlled with a force which has the same direction which force pushes the blade (15) against the counter element (1).

The invention relates to an arrangement in order to tension a counter element, such as a blade of a sawing device which is in combination with the slide block of a roll, such as a blade of a band sawing machine, which counter element can be attached to the body of a sawing device, to a chosen sawing line with the help of a the mentioned counter element and in order to direct the counter element to stay at the mentioned line. The sawing device is a device sawing for example wood, plastics and possible metals, too.

Previously a method is known from the Finnish published application FI-20050790 in order to tension the blade of a sawing device and in order to direct it to make it stay at the intended sawing line in which case in the method the blade needs to be made of magnetable material. In the method a sawing tightening is tensioned to the blade with the help of elements creating magnetic force by moving the mentioned blade in a sideways direction to the intended sawing line, the mentioned sawing line is formed at the part to be sawed which is between the mentioned elements and with the help of the mentioned elements the blade is being controlled all the time during the sawing with the intension that the part meant to be at the sawing line of the blade can be adjusted with no contact to stay at the mentioned sawing line. In the solution the blade is either pulled or pushed with the magnets and no mechanical contact between the blade and the magnet is wanted.

When in this kind of solution the saw becomes burdened and the burdens vary, the band knife immediately tightens and analogously comes loose and the magnets must be able to immediately increase or reduce the pulling/pushing force. The control system must be fast and accurate and it is difficult to keep the band knife exactly at the intended sawing line because the variations in tightness of the band knife aim to move the band knife in a sideways direction.

With the counter element with which the blade of the sawing device, such as the blade of the band sawing machine is being tensioned and is being directed to stay at the chosen sawing line and which counter element can be attached to the body of the sawing device according to the invention the above mentioned problem is solved and unexpected advantages can be achieved regarding the functioning of the blade when the burdens of the blade and the states of tightness vary. It is characteristic of the arrangement according to the invention that the arrangement comprises a magnetic device in order to improve the function belonging to the counter element and in order to improve the sawing result with the help of which magnetic force created by the magnetic device the blade is being controlled with the force having the same direction which force pushes the blade against the counter element.

The advantage of the invention is the fact that the blade can be made to stay more surely at the intended sawing line and in the sawing direction when the blade has a continuous contact with the controlling counter element, such as a slipper pad or a roll with the help of a pressing occurring with a magnet. The sawing can also be directed by turning the blade at different direction angles which turning can be performed by turning the counter element. The contact of the blade with the counter element remains also in this situation. The turning of the blade away from the sawing line which is caused by for example the non-homogeneity of the item to be sawed can be fixed when the position of the blade next to the item to be sawed is explored with the help of sensors and the situation is improved immediately by increasing magnetic force. The control system required for the performing of the improvement is easy to realize.

In the following the invention is described more detailed by referring to the accompanying drawings in which

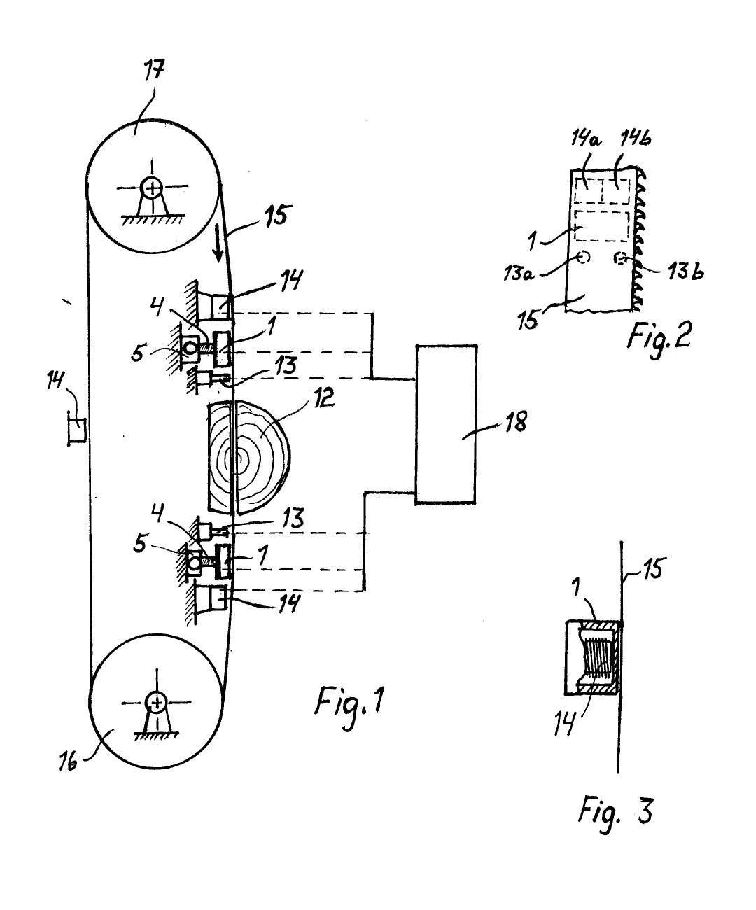

FIG. 1 shows a band sawing machine seen as a side view which band sawing machine has counter elements and magnets according to the invention at the both sides of the sawing point.

FIG. 2 shows the blade of the band sawing machine at the location at which the counter element and other components are located.

FIG. 3 shows a slipper pad as a partial section view.

In the FIG. 1 a sawing situation is shown in which the wood 12 is being sawed with the help of a band sawing machine. The band knife 15 moves through the sheaves 16, 17 and the wood 12 is being fed to move towards the blade. The slipper pads are located at the both sides of the sawing point as counter elements 1 the installation of which slipper pads for the sawing process is made in such a way that they push the band knife 15 slightly outwards (to the right) and tension and tighten the blade 15 at the same time and give a sawing direction for the blade. Between the slipper pads and the item 12 to be sawed there are sensors 13 which explore the position of the band knife 15. In addition to that the sawing device comprises a control centre 18 which controls the magnetic force of the magnetic devices 14 on the grounds of the signals sent by the sensors 13, if needed, if the blade aims to come loose from the slipper pad. The slipper pads can be moved in a sideways direction for example by screwing the conveyor screw 4 and thus one can achieve a desired tightening and a desired sawing direction for the blade.

The band knife 15 is pulled or pushed close to the slipper pads with the help of magnets 1 if the blade for some reason aims to move outwards for example due to a tightening which is too insignificant. The sensors 13 indicate this loosening and the traction power of the magnets 14 is then increased regulated by the control centre 18. The magnets have most advantageously a pre-adjusted basic pulling or pushing force and it is increased, if needed. The usage of magnets requires that the blade 15 is made of magnetable material. The magnets can also be permanent magnets. The magnet 14 can be located also at the back of the blade 15 behind the sawing device, such as in the FIG. 1. When the blade 15 is being pulled or pushed with this magnet 14, then also the blade 15 is being tightened and is being pushed at the same time against the counter elements 1.

The body of the sawing device which comprises the slipper pads 1, sensors 13 and magnets 14, is formed to be moveable in relation to the actual body of the sawing device in which case by moving this body part the moving of the band knife 15 is performed outwards into a tensioned state.

With the help of the control centre 18 the both slipper pads are adjusted simultaneously. If the sensors 13 indicate that the blade 15 is about to come loose either at its front or rear edge regarding one or the other slipper pad, the parallel magnets 14a, 14b can for example be controlled separately and forces of different strengths can be gained at the front and rear edge of the blade which forces push against the slipper pad.

In the FIG. 2 the slipper pad is shown in relation to the band knife 15. There are two sensors 13, 13a and 13b in which case the loosening of the blade 15 from the slipper pad or the direction at the location of the sensors is recognized with the help of these sensors. With the help of the control center 18 a stronger force can be adjusted to the other magnet and the blade 15 can be pulled or pushed against the slipper pads in such a way that the direction of the blade becomes fixed.

In the FIG. 3 a slipper pad is shown inside which a magnetic device 14 is adjusted. The magnet 14 is covered by the slipper pad 1 and does not collect very easily metallic dust to itself.

1. Arrangement in order to tension a counter element (1), such as a blade of a sawing device, such as a blade (15) of a band sawing machine in combination with a roll or a slide block to a chosen sawing line with the help of the mentioned counter element and in order to direct the counter element to make it stay at the mentioned line, characterized in that the arrangement comprises a magnetic device (14) in order to improve the functioning belonging to the counter element (1) and in order to improve the sawing result with the help of which magnetic force created by the magnetic device the blade (15) is being controlled with a force which has the same direction which force pushes the blade (15) against the counter element (1).

2. Arrangement according to the claim 1, characterized in that the counter element (1) can be moved into various positions which tension the blade (15) and its direction can be adjusted into various directions which direct the blade (15).

3. Arrangement according to the claim 1, characterized in that the magnetic device (14) either pulls or pushes the blade (15).

4. Arrangement according to the claim 1, characterized in that the magnetic device (14) is divided into two or more parallel sections (14a), (14b).

5. Arrangement according to the claim 1, characterized in that the magnetic device (14) is a permanent magnet or a electric magnet.

6. Arrangement according to the claim 1, characterized in that the arrangement comprises one or more sensors (13) recognizing the position of the blade (15).

7. Arrangement according to the claim 1, characterized in that there are counter elements (1) and magnetic devices (14) at the both sides of the billet (12) to be sawed.

8. Arrangement according to the claim 1, characterized in that the magnetic devices (14) are located further from the wood (12) to be sawed than the counter elements (1).

9. Arrangement according to the claim 1, characterized in that the magnetic devices (14) are located closer to the wood (12) to be sawed than the counter elements (1).

10. Arrangement according to the claim 1, characterized in that the magnetic devices (14) are located to the counter element (1) in order to control the blade (15) through the counter element.

11. Arrangement according to the claim 1, characterized in that the magnetic devices (14) are located to the return side of the blade at the back of the saw.
